(19) United States
(12) Patent Application Publication
(10) Pub. No.: US 2013/0339205 A1
(43) Pub. Date: Dec. 19, 2013

(54) Asset Valuation and Quantifying Personal Worth

(71) Applicants: Robbie Vann-Adibe, San Francisco, CA (US); Young J. Shin, San Francisco, CA (US); Charles S. Han, San Francisco, CA (US); Andrew M. Pease, San Francisco, CA (US); S. Michael Perlmutter, Sausalito, CA (US)

(72) Inventors: Robbie Vann-Adibe, San Francisco, CA (US); Young J. Shin, San Francisco, CA (US); Charles S. Han, San Francisco, CA (US); Andrew M. Pease, San Francisco, CA (US); S. Michael Perlmutter, Sausalito, CA (US)

(21) Appl. No.: 13/901,204

(22) Filed: May 23, 2013

Related U.S. Application Data
(60) Provisional application No. 61/650,744, filed on May 23, 2012.

(51) Int. Cl. G06Q 40/00

(52) U.S. Cl. CPC G06Q 40/00
USPC 705/35

(57) ABSTRACT

An asset tracking and reporting system has a network-connected computerized appliance having at least one processor and one or more data repositories, at least one of the data repositories being non-transitory and coded instructions executing on the at least one processor from the at least one non-transitory data repository. The coded instructions causing the system to register individuals or enterprises as users assuming one or more roles, enable users to enter and edit information through interactive interfaces provided, the information regarding individual assets in defined categories, the assets owned by the user, track user activities related to user's assets, connect users to resources to determine value for the individual assets, and to aggregate and report asset valuation according to user identity.

### CROSS-REFERENCE TO RELATED APPLICATIONS

The present application claims priority to U.S. provisional application 61/650,744, filed May 23, 2012, and the disclosure of the provisional application is incorporated in its entirety at least by reference.

### BACKGROUND OF THE INVENTION

1. Field of the Invention

The present invention is in the technical field of financial services, and pertains more particularly to evaluating physical assets as a part of evaluating personal worth.

2. Description of Related Art

In current art, evaluation of net worth for various financial purposes quite often ignores a very important part of what may constitute individual or enterprise net worth, simply because there are certain types of assets that are resistant to quantification for the purpose. Examples are collectable items such as vintage automobiles, antiques, coin collections, art collections and the like. The real value of these sorts of assets is seldom taken into account for many purposes, because, until the present invention, there was no way to assign a reliable value, and to track the past, present and potential future value of such assets.

There exist in the art systems for tracking personal and enterprise net worth, but the value projected often is not complete because of the difficulty of including value of the asset types alluded to above. Therefore, what is needed in the art is a system and methods to determine individual or enterprise overall net worth, sufficiently flexible to accommodate asset types that may vary widely in terms of their characteristics, and yet may allow summation and aggregation of that information in such a manner as to allow a calculation of overall net worth to occur. The characteristics of an investment property, a case of Petrus wine, or a vintage Ferrari automobile are very different and yet the value of each might contribute significantly to an overall net worth calculations about widely differing asset types.

In some embodiments the invention provides a general, unified cataloging of assets that leads to facilitation of an aggregation valuation methodology of assets. The asset cataloging infrastructure and aggregation valuation methodology can work in isolation (that is, with an individual using the system privately), but it is most effective using crowd-sourcing, which involves leveraging community cataloging and valuation of like assets. In addition, in some embodiments a public asset exchange schema that may be realized in several file formats and application programming interfaces (API) is provided.

### BRIEF DESCRIPTION OF THE SEVERAL VIEWS OF THE DRAWINGS

FIG. 1 is an architectural drawing in an embodiment of the invention.

FIG. 2 is an architectural drawing regarding back end elements in an embodiment of the invention.

FIG. 3a is an example of an interactive interface facilitating Audit functionality in an embodiment of the invention.

FIG. 3b is a further interactive interface reached through the interface of FIG. 3a.

FIG. 4 is an example of an interactive interface facilitating Advise functionality in an embodiment of the invention.

FIG. 5 is an example of an interactive interface facilitating Activity functionality in an embodiment of the invention.

FIG. 6 is an example of an interactive window facilitating a marketplace withing the system for sale and trade of assets among users.

FIG. 7 is an example of an interactive window summarizing assets and information for a user as a start page in an embodiment of the invention.

FIG. 8a is an example of an interactive interface displaying valuation for asset categories for a user.

FIG. 8b is an example of an interactive interface displaying further detail of a selected category from FIG. 8a.

### BRIEF SUMMARY OF THE INVENTION

In an embodiment of the invention an asset tracking and reporting system is provided comprising a network-connected computerized appliance having at least one processor and one or more data repositories, at least one of the data repositories being non-transitory, and coded instructions executing on the at least one processor from the at least one non-transitory data repository, the coded instructions causing the system to register individuals or enterprises as users assuming one or more roles, enable users to enter and edit information through interactive interfaces provided, the information regarding individual assets in defined categories, the assets owned by the user, track user activities related to user's assets, connect users to resources to determine value for the individual assets, and aggregate and report asset valuation according to user identity.

In one embodiment a profile is established for each user, the profile identifying the user and the user's roles, and linking to the information regarding the user's assets. Also in an embodiment one defined role is expert, and detail of the user's expertise is included in the user profile, made accessible to other users. Still in one embodiment the expert user is an expert in evaluating worth for one or more specific categories of assets.

In one embodiment users are enabled to communicate with one another and records of communication are recorded and stored as threads associated with the users in each communication. In some embodiments individual users are enabled to retrieve and utilize communication threads in asset management. Also in some embodiments individual users are enabled to retrieve and utilize recorded user activities in asset management.

In one embodiment user communication is leveraged to provide a vehicle for sale and trade of user's assets. Also in one embodiment individual users are provided with a starting page after log in, the starting page displaying at least a financial overview for the user according to asset type. Also in one embodiment at least one aggregate score is determined for a user, the score determined by aggregating weighted values of scores determined per defined asset category for the user, and scores are made available to interested parties.

In another aspect of the invention an asset tracking and reporting method is provided comprising registering individuals or enterprises as users assuming one or more roles by a network-connected computerized appliance having at least one processor and one or more data repositories, at least one of the data repositories being non-transitory, the processor executing coded instructions on the at least one processor from the at least one non-transitory data repository, enabling users to enter and edit information through interactive interfaces provided, the information regarding individual assets in defined categories, the assets owned by the user, tracking user activities related to user's assets, connecting users to resources to determine value for the individual assets, and aggregating and reporting asset valuation according to user identity.

In one embodiment of the method a profile is established for each user, the profile identifying the user and the user's roles, and linking to the information regarding the user's assets. Also in one embodiment one defined role is expert, and detail of the user's expertise is included in the user profile, made accessible to other users. Still in one embodiment the expert user is an expert in evaluating worth for one or more specific categories of assets.

In one embodiment users are enabled to communicate with one another and records of communication are recorded and stored as threads associated with the users in each communication. In some embodiments individual users are enabled to retrieve and utilize communication threads in asset management. Also in some embodiments individual users are enabled to retrieve and utilize recorded user activities in asset management.

In some embodiments user communication is leveraged to provide a vehicle for sale and trade of user's assets. Also in some embodiments individual users are provided with a starting page after log in, the starting page displaying at least a financial overview for the user according to asset type. Still in some embodiments at least one aggregate score is determined for a user, the score determined by aggregating weighted values of scores determined per defined asset category for the user, and scores are made available to interested parties.

### DETAILED DESCRIPTION OF THE INVENTION

The inventors first provide a general description of an embodiment of the invention, followed below by more detailed description with examples and enabling detail. In the more general case the invention, in some embodiments, provides two general and coupled mechanisms for evaluating assets:

1. a mechanism that catalogs assets for users using an audit/advise/act (AAA) infrastructure which includes facilitation of valuation of individual assets.
2. an aggregation past/present/future valuation methodology that leverages information from 1.

In addition to the above, when used in conjunction with crowd-sourcing, mechanism 2 provides more information for valuation of similar assets.

### Audit/Advise/Act Asset Cataloging Infrastructure

In the Audit process:
The AAA infrastructure allows users to catalog their assets in a generalized, uniform manner. Assets are grouped within an asset class or type, for example, real estate, collectible cars, ventures, or stocks. Users interact with the infrastructure to catalog their assets and may make any parts of the cataloging public. This publishing of cataloged data facilitates crowd-sourcing with respect to cataloging refinement, valuation, ranking, and a marketplace which is inherent in the infrastructure. There are alternative ways that functions may be separated in different processes.
In one embodiment in the Audit process, users may:
specify attributes and attach documentation of a particular asset within the relevant asset class.
add activities, and attach relevant documentation to the particular asset. Valuations may also be associated with the activities. For example, an event (activity) may cause an increase or decrease in the value of the asset instance.
   In the Advise process, users:
can ask questions about a specific asset to the community of users of the system, since the infrastructure supports communication among users.
can view content from contributors.
   In the Act process, users:
can initialize actions on a specific asset which may or may not turn into activities for the particular asset.

Information entered and received in these processes may facilitate valuation of specific assets. On a timeline of a specific asset, which may have surfaced in the Audit process, milestones of the asset (activities of the user's asset or community input on relevant assets) are highlighted allowing the user to input a valuation for the asset at specific points in time. In addition, the timeline extends into the future, allowing the user to predict the value of the specific asset at specific future points in time. Again, this future valuation is facilitated by the infrastructure providing community input on the valuation of relevant assets.

In an alternative embodiment “activities” is a part of the “Act” process. In another alternative embodiment different types of activities may be part of either the Act or the Audit processes.

### User Interface Considerations:

The infrastructure workflow is coupled with a visualization mechanism that facilitates the workflow.

### Reference Data:

The system also provides reference data for an asset class. For example, an administrator account holds a database of automobiles in existence. Users may use this reference data as a starting point to catalog and value their own similar assets.

Aggregate Past/Present/Future Valuation Methodology In one embodiment assets may be categorized in the following manner:
P: personal (examples: property, consumer goods)
A: alternative (examples: collectible cars, wine)
I: illiquid (example: ventures)
L: liquid (example: cash, stocks, bonds)
L: liabilities (example: loans, bank lines, credit)
   The valuation methodology in an embodiment of the invention is a hierarchical aggregate. That is:
1. The user values specific assets of an asset class at specific points in time in the Audit/Advise/Act infrastructure.
2. The specific asset valuations may be aggregated to form a composite valuation of the asset class.
3. Relevant asset classes may be aggregated into one of the four above categories.
4. The aggregation of the valuations from (3) forms a complete valuation profile.

This valuation methodology provides a mechanism to generate continuous timelines of the past, present, and future valuations in year, month, week, and day granularity going from the event-driven, single timestamp valuations of specific assets up to a complete aggregation.

### User Interface Considerations:

The valuation methodology is coupled with a visualization mechanism that facilitates the methodology.

### Reference Data:

As noted in the previous section, the infrastructure provides reference data for a particular asset class in an administration account. It will also catalog events and activities that occur against this reference data that will affect valuation of similar assets. For example, if a particular automobile is sold at an auction, the activity will be cataloged against the reference automobile that matches the sold one, and this information is then publicly available as a valuation reference for users to value their own assets.

### Crowd-Sourced Data:

While the default status of the cataloging of assets is private, users can choose to make parts of their portfolio public including valuations that may or may not be associated with activities. When this information is publicly available, as with the reference data, it serves as a valuation reference for other users to value their own assets. In other words, it serves as a valuable mechanism to set the marketplace.

### Public Asset Schema

Leveraging the presented generalized, unified infrastructure for asset cataloging and valuation, the invention in many embodiments includes an asset file exchange format for the infrastructure and third-party services to generate and consume. This schema is described in a Unified Modeling Language (UML) with API bindings and file exchange formats including but not limited to:
C++
Java
Javascript
Ruby
XML
JSON
YAML

The schema may be generalized and extendible. The inventors maintain the schema for public consumption and generation as well as extensibility.

The invention is described in enabling detail in the following pages and with reference to the drawing figures introduced above in the Brief Description of the Several Views of the Drawings.

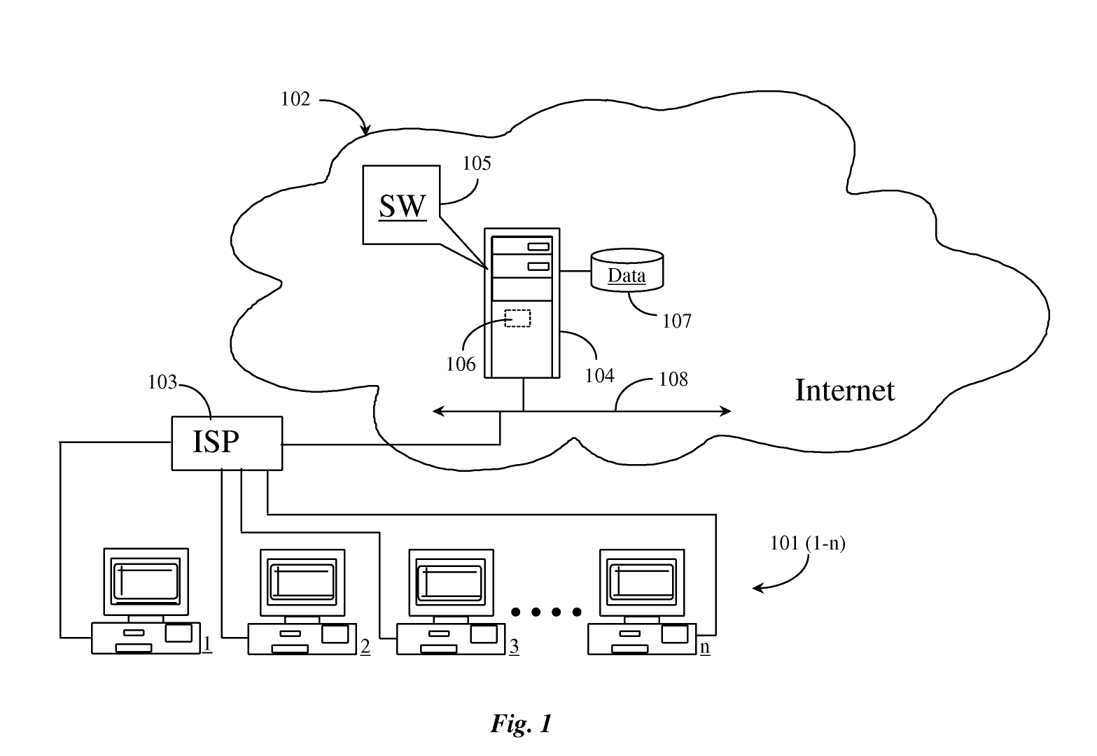

FIG. 1 is an architecture diagram in an embodiment of the invention. Users 101 (1-n) connect to the Internet Network 102 through any one of a variety of Internet Service Providers, which are indicated as ISP 103 in FIG. 1. It will be apparent that not all users will connect by the same means or the same path, and that there is a broad variety of different land-line, cable and wireless systems whereby users may connect to the Internet. The simplified structure shown is meant to represent all the different ways that users might connect. It is also true that not all users will connect with a common platform. Users may operate in embodiments of the invention from essentially any platform that is capable of Internet connection, and provides a display for an interactive interface.

User's 1-n connect at various times through Internet backbone 108, representing all of the myriad connections paths and sub-networks in the Internet network, to a web-based server 104, which executes software (SW) 105. There may be more than one such server operating in cooperation, such as, for example, one or more back-end servers that may serve and execute applications, but one server serves to illustrate functionality in embodiments of the invention.

Server 104 provides services, through execution of SW 105 by at least one processor 106 in embodiments of the invention, such as the services described herein as falling into the classes of Audit, Advise and Act. Services are enabled in one embodiment through interactive interfaces provided to users through execution at the user's platform of a commercially available web browser.

Server 104, keeping in mind that this may represent a collection of servers, has access to one or more storage facilities, represented herein by database 107. Database 107 stores executable software, statistics, data relevant to users and assets, and all other code and data that may be necessary to facilitate operation of the invention in various embodiments. Database 107 may in fact be a collection of digital storage mechanisms of several different sorts, and storage may be in any one or more of a variety of protocols.

### User Data

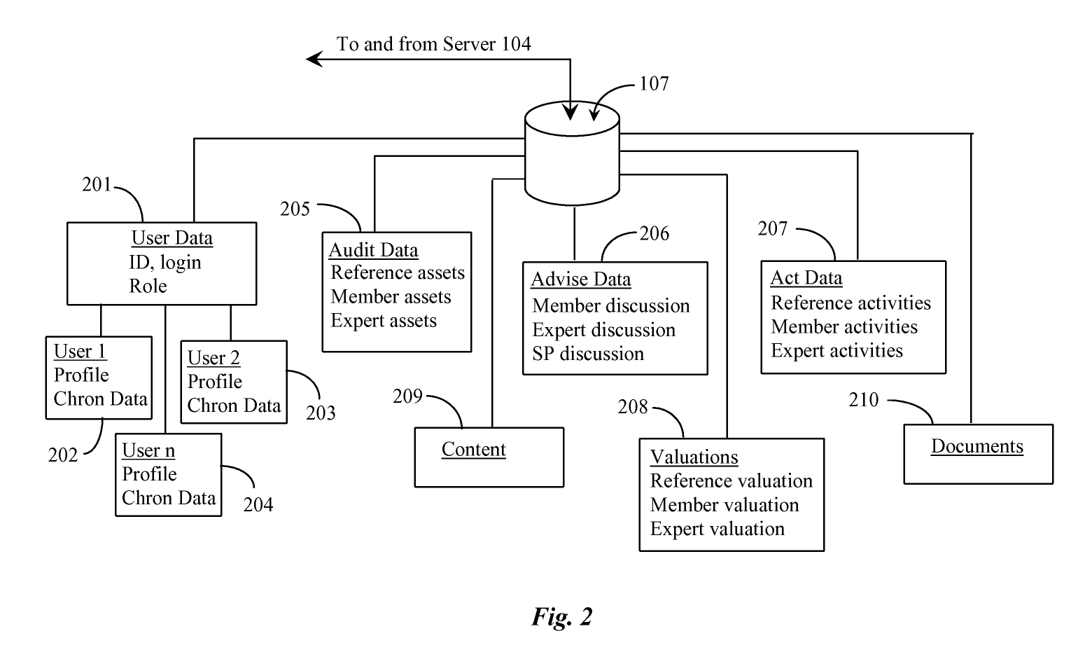

FIG. 2 illustrates high-level organization of data in dB 107 in one embodiment of the invention. dB 107 is illustrated as a single entity, but may well be a plurality of digital storage mediums in various places. Block 201 represents user data in dB 107.

All users must register to use the services of the system in embodiments of the invention, and each user will have a user ID, a username, a password, and at least one user role. Registration may be accomplished through interactive windows provided to a user's appliance through browser SW in one embodiment. In the registration process users may be asked to enter substantial information.

An important object of the invention is to provide users with a method and system to enable efficient and accurate assessment of value for assets of the user not typically easy to evaluate, such as art, book collections, personal property like boats, aircraft and high-end cars, for example. To accomplish this for individual users, there need be registered members who are not persons seeking evaluation of assets and judgments of personal worth, but persons who are experts in appraisal of various sorts of assets, sponsors, service providers and experts of various sorts.

Upon registration a user may first be asked to declare a user role, such as member, expert, service provider reference user, and so forth. Roles will be defined in the system, but definitions may be updated from time to time. Based upon the user's response further questions to the registering user may take different forms, based at least partly on the role the user selects. Users may typically have one role in the system, but there is no impediment to a user having more than one role. The user's interaction with the system, may, however, be guided by the particular role the user assumes at different times.

Each user may be provided with an individual user profile, three of which, 202, 203 and 204, are illustrated in FIG. 2. There may, of course be hundreds of users or more. The profile may designate users as to the defined roles. Roles may include member, expert, service provider, sponsor or reference user. The user profile will also couple to chronological data specific to each user. As a user interacts with the system, the user's activities may tracked and recorded and records stored identified by user, so users and administrators may review data as necessary for various purposes.

Roles may be further defined according to type. An expert, for example, may be further categorized as an automobile expert, and even further by vintage auto, sports car, etc.

A special user is the reference user. As is described in more detail below, this user has reference assets, activities, valuations, and content that is either used as template or reference data. Expert, sponsor, and service provider's roles go through a meticulous vetting process. An important purpose of these roles is to add high value to the community.

In some embodiments of the invention users can rate other users based on their data and depending on their roles. For example, users that do not have any associated roles will not be able to rate other users. Rating may also be determined on metrics of the data (for example, participation in discussions, verified appraisal of assets, etc.).

As an important object is to provide for individual users specific valuation for assets of various sorts, a user will enter assets, along with defining information about each asset, and through services of the system, will be able to determine a real time value for each asset, as well as sub-total values for classes of assets, and an overall value for all tracked assets. The values for assets are dynamic, and are subject to change as new events take place and new information is made available.

### Audit Process and Data

Next in FIG. 2 is Audit data 205 associated with asset data. The audit data is categorized in multiple ways, such as any one of reference, member, or expert data owned by a user. Another categorization has to do with aggregate valuation in a methodology the inventors term PAIL, and this is addressed in a valuation discussion below. The reference data is a database of the known values for a variety of reference assets. For example, for the asset class Automobiles, there is a database of automobiles that is as all-inclusive as possible. This data may be used as both a template to guide members (and experts) to instantiate their own assets, and, depending on the richness of the data, the reference data may be referenced by member or expert data, but then can be individually overridden. For example, for an automobile, reference data may include “torque” that can be overridden by the user. Asset instances may have associated documents—images, text documents, etc., and all of this reference information is made available to users for comparison and use in evaluating their own assets.

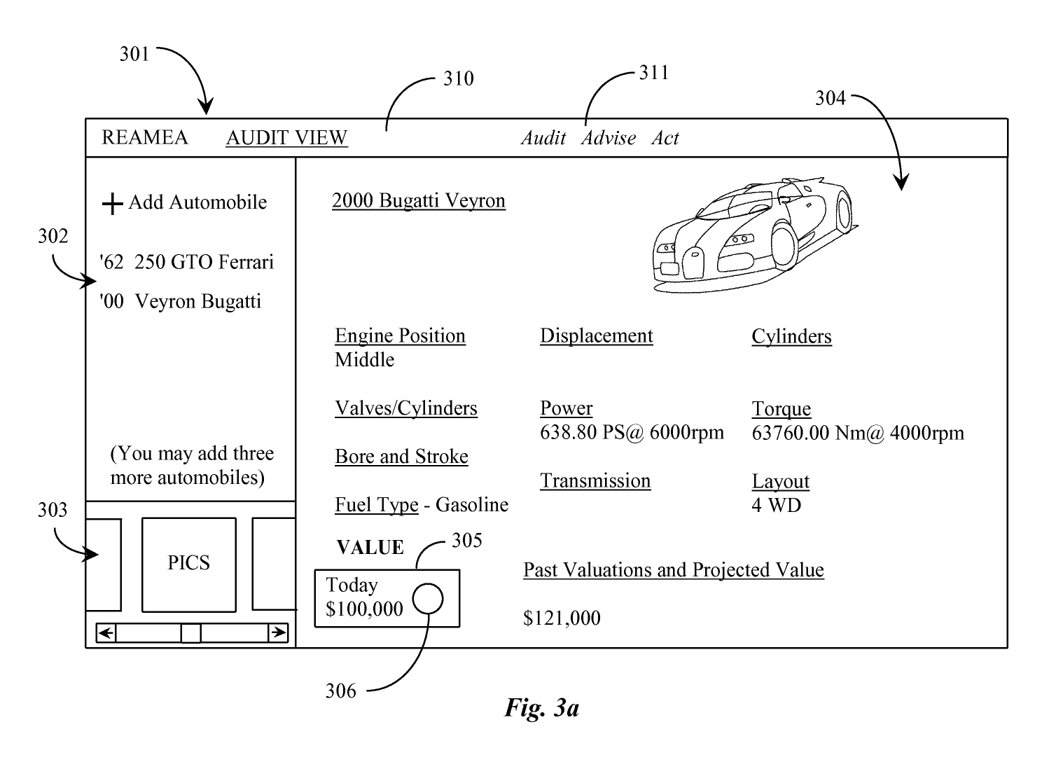

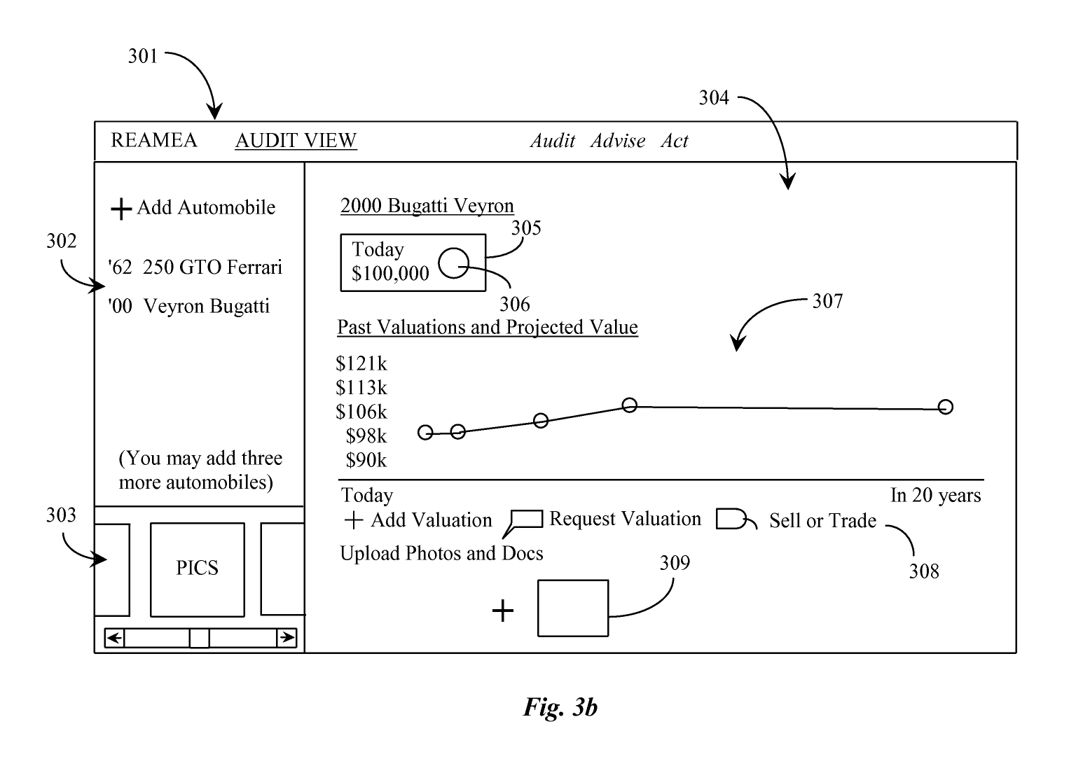

FIG. 3a illustrates an Audit interactive interface 301 made available to users, through which users may determine value for certain assets. This interface is closely associated with automobiles as an example, but there may be a multiplicity of such interfaces, each dedicated to another asset type, such as, for example, jewelry,

For this, and for each interactive interface, there is a caption and navigation bar 310. A system or enterprise name may be presented here, in this case “REAMEA”. The particular view that is associated with the interface is indicated, in this example “AUDIT VIEW”, and links 311 are provided for the user to switch to another view as desired. These links may be words, phrases or icons.

The upper-left panel shows a list 302 of asset instances, in this case two automobiles, which have been entered by a user. In the lower left 303 there is a coverflow UI of the automobiles listed above, scrollable to see each of the listed assets. The larger right panel 304 provides detail of a selected instance. While the details of the right panel will be customized per asset class, the idea of data being referenced from the reference data as previously described will be consistent with what is shown here (the torque example is presented as one of the reference attributes that can be overridden by the user). At 305 there is an indication of the current value of the selected asset (automobile).

FIG. 3b is an interactive interface that may be reached by clicking on link 306 of FIG. 3a. The left panel stays essentially the same as in FIG. 3a, but the right panel now depicts a plot 307 of value for the selected asset vs. time, showing projected value from now out twenty years. Facility is provided with links 308 for adding valuation, requesting valuation and Sell or Trade. Link 309 controls and facilitates uploading of photos and documents.

An important principle concerning the audit content of all assets is the level of privacy. By default, all member asset instances are private, but users can elect to make all or a part of their assets public to the community. Reference asset data is always public, and expert asset data will default to public. The documents associated with member asset instances also default to private.

### Advise Data and Process

Advise is all about discussions among users. Referring again to FIG. 2, data relative to Advise activity is represented at block 206. As with Audit, Advise data is categorized by the user role and as the user's own posts and comments. In some embodiments there are member, expert, and service provider discussions (and responding comments). These discussion threads, both the initial post and subsequent comments, can reference assets, documents, and activities.

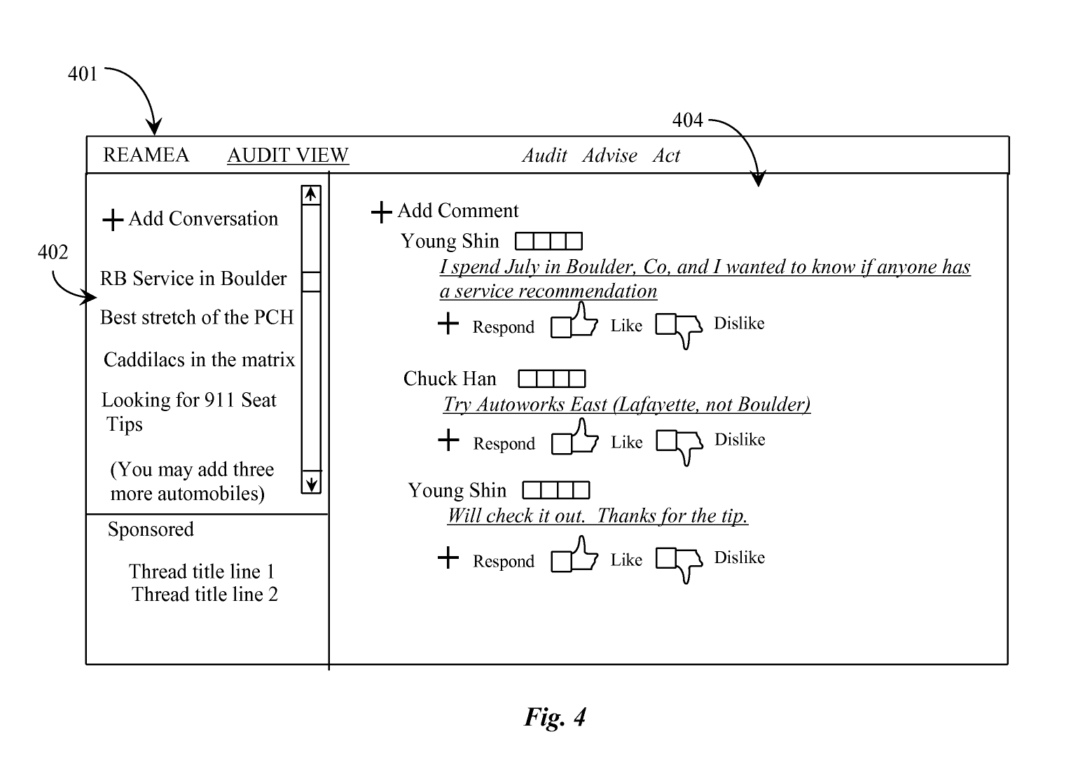

FIG. 4 illustrates an Advise interactive interface, enabling users to interact and discuss. The layout is similar to the Audit interface, in that instances of discussions are listed in the upper-left panel 402, and the right panel 404 shows the details of a selected discussion thread. A scroll bar is provided so listed discussion threads in the left panel may be scrolled and selected. A user can add a new comment or question, starting a new thread, or may respond to another user's comment Like and Dislike tags are also provided as shown.

An important mechanism in an embodiment of the invention involves filtering of discussion threads. This filtering may be done by keywords (for example “Porsche leather seats”) and references (for example, show discussions of a particular asset such as Porsche 911s). In addition, the user can select discussion threads of an expert (for example, the user follow automobile experts), or members who have achieved a certain rating.

Discussions are made public when users elect to “publish” their posts and comments. Note that if a referenced piece of data is not public, that reference data will not be made public.

### Act Process and Data

Act data is represented in FIG. 2 at block 207, and as with Audit and Advise Data, Act data is categorized by user type as users own assets and activities are associated with assets. Activities may range from usage of an asset (for example, a drive of an automobile), regular maintenance, appraisal, buying, selling, trading, and more. Activities can have associated data such as documents or, as in the case of a drive of an automobile, custom content like the mapping of the drive route.

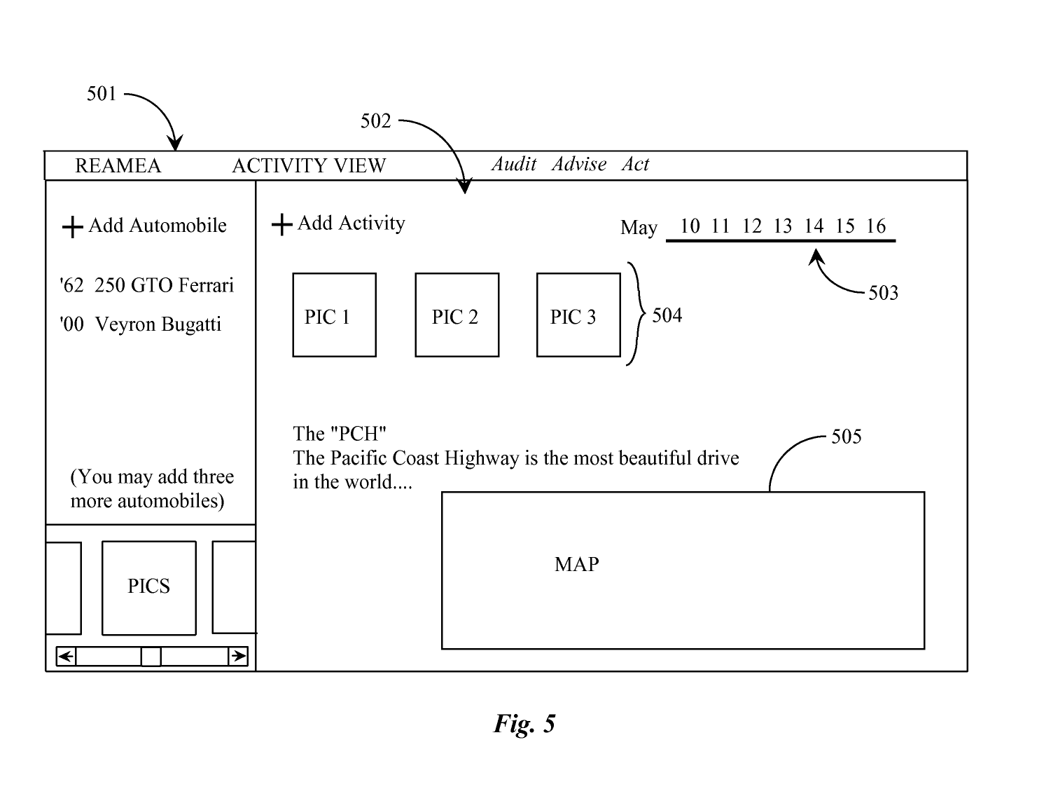

FIG. 5 illustrates an Activity window 501 in an embodiment of the invention. Activities may be entered, stored, and retrieved for selected assets. In this case the asset is one of the automobiles (Veyron Bugatti) belonging to the member using the system, and the activity is a drive along the Pacific Coast Highway in California, from San Francisco to Santa Barbara. Details of the activity may be displayed on right panel 502. For example, a map 505 of the drive is shown. Pictures 504 at various points and times along the drive may be stored and presented in the activity view. A timeline 503 allows the user to change the time, for which details of the activity will be displayed accordingly.

As with assets, activities associated with member assets are by default private. However, activities associated with reference user assets are always public, and activities associated with expert assets are by default public.

In general, an activity is associated with a specific instance of an asset, but in the case of reference users, an activity is associated with all like instances. For example, if a 1965 Porsche 356c was sold at an auction, that activity could be associated with the similar reference asset instance, and since this is a public activity, it may be accessible to all users.

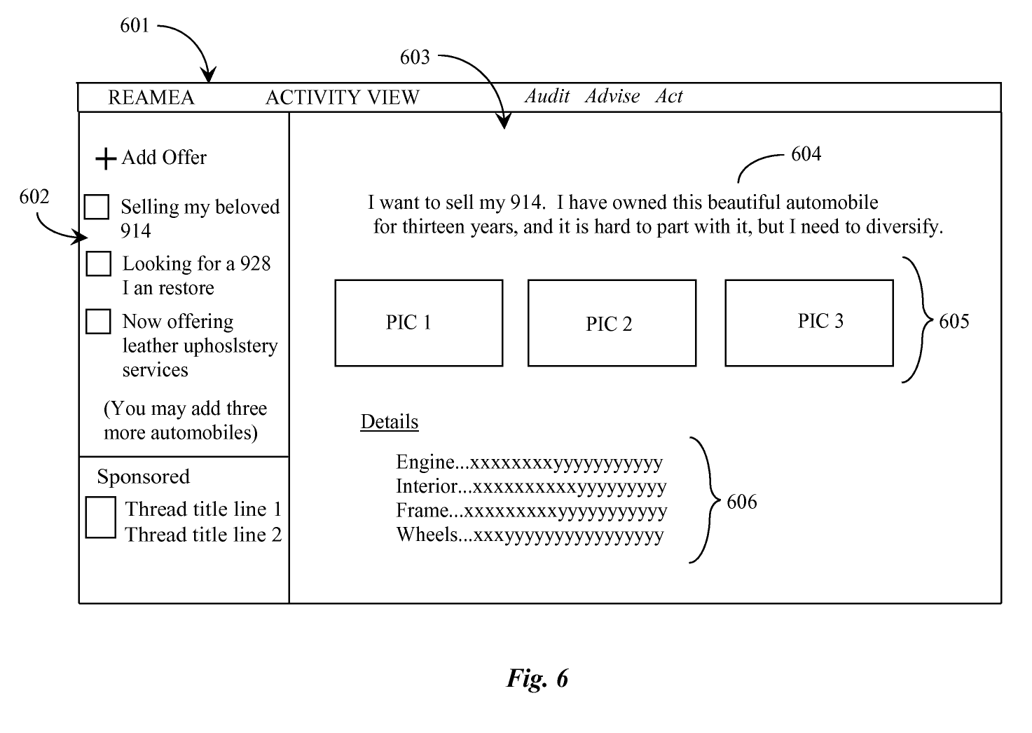

FIG. 6 shows a workflow 601 for a transactional activity in the form of an offer for sale. The format is the same as Audit and Advise in that a list of offers 602 is shown in the upper left panel and selecting an individual offer displays the details of the selection in the right hand panel 603. A statement and comments by the owner may be presented at 603, pictures may be provided at 605, and details concerning the automobile may be provided at 606. This functionality provides a marketplace, at least among registered members of the service, for goods and services. As with the Advise schema, users may be able to filter offers by various criteria.

### Valuation

Referring yet again to FIG. 2, data block 208 references asset valuations. There are two types of valuations: those that are not associated with activities and those that are associated with activities. Those that are not associated with activities are, for example, used in future valuation predictions of an asset instance as shown in FIG. 2b. Examples of valuations associated with activities include the appraisal value, buy/sell price, etc.

Member valuations are by default private. Reference user valuations are always public (again, like the sale of an automobile at an auction). Expert/Sponsor/Service Provider valuations are by default pubic. Public valuations of like assets helps a user value the his or her own assets. Some valuations such as those against reference data or those from experts may have more influence for a user, and the user will be able to filter valuations according to roles and ratings of users.

Yet another data block in FIG. 2 is block 209 dedicated to Content. Content is owned by a particular user, and as with Advise content, it can have associated references. Content can be delivered to other users depending on set filters. For example, a user might be interested in content from a particular expert, users with a certain rating, or content associated with asset instances of interest. Documents are stored in data block 210, associated primarily with users.

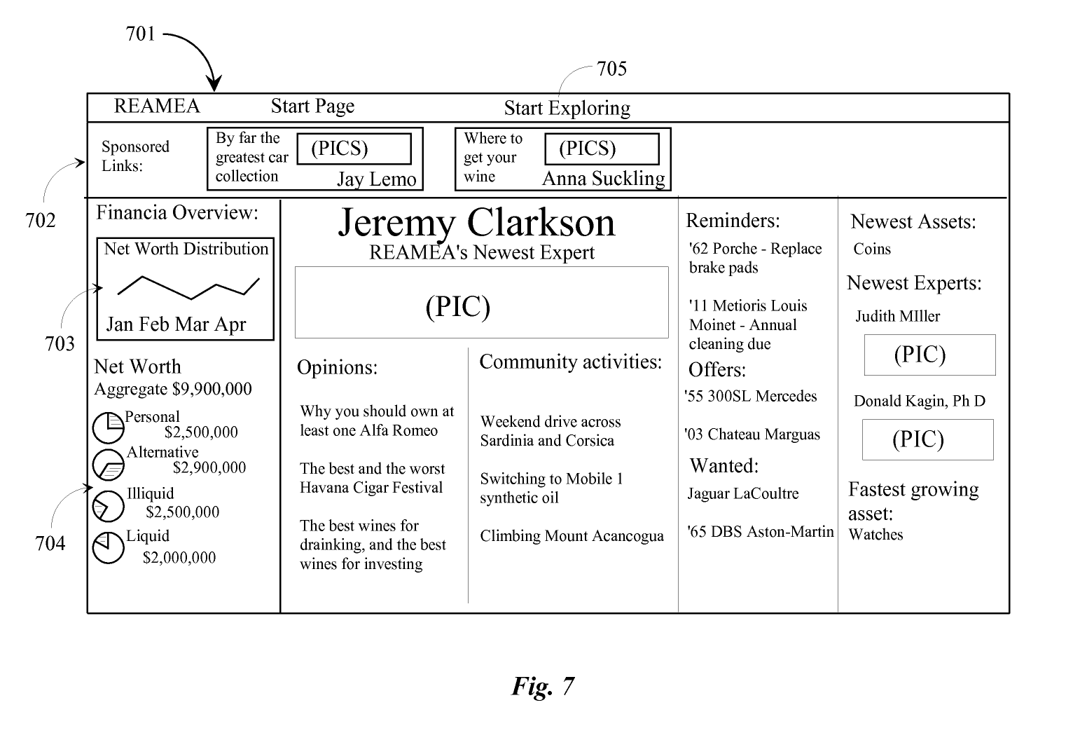

FIG. 7 illustrates a first interactive page 701 displayed when the user first signs in. This page shows examples of sponsored content 702 and considerable detail of the user/member, Jeremy Clarkson, who has logged in. A Financial Overview, discussed further below, is provides at 703 and 704. Activities that are public to this user and filtered according to the user's preferences, and other relevant information to the user is displayed in various sections. A link 705 enables the user to access menus to navigate to other pages and views, and to add, edit and act in the realm of the system, including interacting with other users. Each user has a start page following this general format.

### PAILL: The Financial Overview

As noted earlier, assets may be categorized by user role, but assets may also be categorized in a PAILL (Personal/Alternative/Illiquid/Liquid/Liabilities) aggregate valuation scheme. An asset class categorized into one of these categories may also be categorized in multiple categories. As an example a block of stock in a publically-traded company might be categorized as a personal asset, but it may be liquid or illiquid, depending on whether that block of stock is encumbered as security for a loan or other purpose. As another example, a collectible automobile as an alternative asset would normally be illiquid, as such entities are typically stored somewhere and not continuously offered for sale. But in some cases such an asset might be paired with a “standing offer” by an interested party that has liquid assets. That auto might be easily and readily converted to cash at need, and therefore might be considered a liquid asset.

The PAILL categorization for evaluation provides a financial overview of all assets cataloged for a particular user or enterprise. And, it is noted that enterprises and organizations may in some embodiments of the invention be “users”. Typically, for an enterprise, like a law firm, for example, the Start page will list the enterprise by name. The actual user will be one or another of persons designated by responsible managers of the enterprise as enabled to operate in the system on behalf of the enterprise.

Net worth is a concept typically associated with individuals, but it should be clear that the functions of this invention in various embodiments may operate to express worth of groups of people, such as a trust or an estate, and for non-profit organizations and other enterprises, including for-profit businesses.

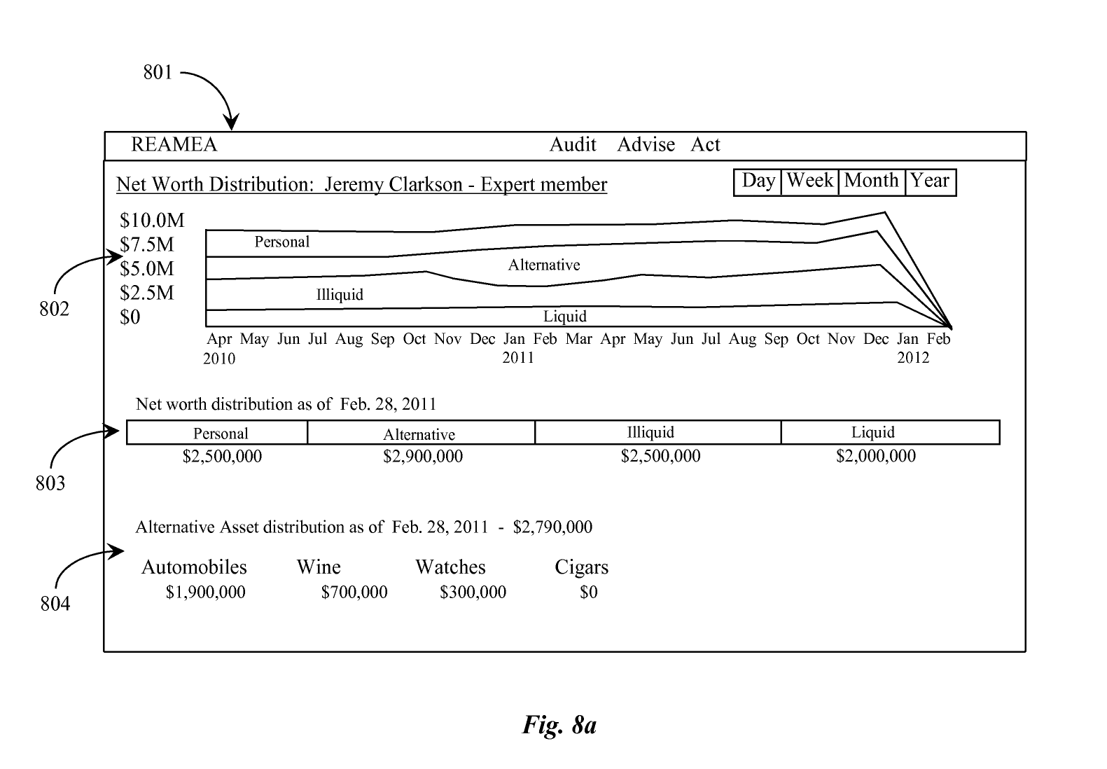

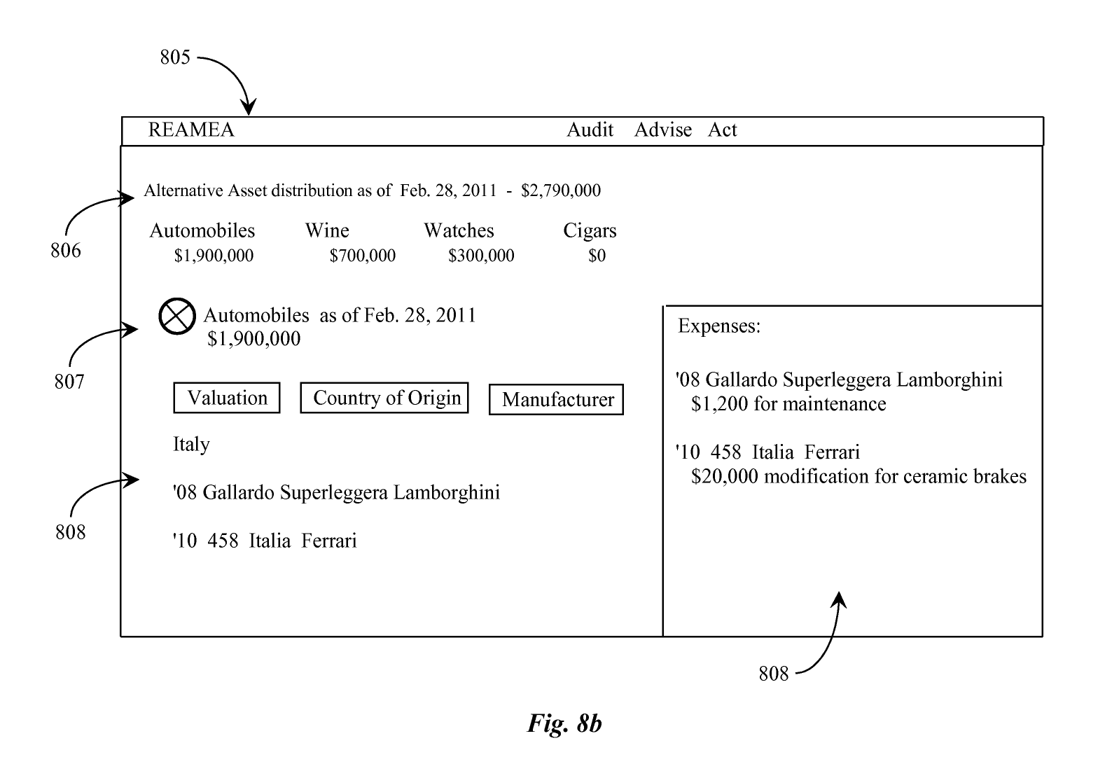

FIG. 8a illustrates a top-level overview 801 of each of the PAIL categories. Net worth distribution is displayed at 802 and 803 in different ways. Alternative Asset distribution is displayed at 804.

FIG. 8b shows a drill-down display 805 into the “A” or Alternative Asset Distribution. Further drilling down will surface a particular asset class at which point the user can navigate to the asset class itself. The Alternative Asset Distribution from FIG. 8a is repeated at 806. Having selected automobiles, The value for Automobiles is displayed at 807, and a selection interface is provided for Valuation, Country of origin and Manufacturer. If Country of Origin is selected as Italy, all automobiles originating from Italy are listed at 808. A side panel 809 lists expenses during a selected month for each of the automobiles listed at 808.

In one embodiment of the invention at least one PAILL score is maintained for individual ones of users, either individual persons or group entities, and that score is created by one or more algorithms that may apply weights to the categorizations of assets in the asset landscape for that user, and sums weighted scores over the landscape. It should be understood as well that there may be, in most cases will be, a variety of PAIL scores determined and maintained for individual users, as the weighting is heavily dependent on the intent and purpose of the person who seeks that score for another person or group entity. So there may be different PAILL scores maintained, and users may be provided with an input to select which of several PAILL scores are of interest.

In an embodiment of the invention PAILL scores may be maintained for a person or a group entity in much the same way as a credit score is determined and used in credit assessments and valuations in current art. In some embodiments PAILL scores may, with agreement by members, be provided to other persons or organizations on request, and service fees may apply.

Existing standards for evaluating credit worthiness, such as FICO scoring or other standard methods are woefully inadequate for the sorts of users that may be members of the system in various embodiments of the invention. This is at least partly because most of these members will be relatively wealthy individuals, and may keep a substantial portion of their value in assets that may be difficult to evaluate quickly and cleanly. The valuation methodologies described herein provide a standard for making credit worthiness decisions. These decisions can be based on the past, present, and future calculations separately or in any combination.

### Standardized Data Manipulation and Transfer

In one embodiment of the invention a data structure and data determination and management system is provided that the inventors term Asset XML (AXML). AXML is an asset determination and management protocol and manipulation method developed in Extensible Markup Language (XML). The formulations in this special language and system are particular to the asset categories described above, and involve unique algorithms and determination schemes particular to various embodiments of this invention. The structure and methods resulting from AXML allow valuations to be quickly determined as new information becomes available, which is seen as necessary because the valuations of assets over one person's or enterprise's asset landscape are known to be often rapidly changing, and near real time information is seen to be critical. In addition, AXML allows import and export to be accomplished seamlessly, and opens the system of the invention to use by a great variety of other institutions.

It will be apparent to the skilled person that there are many alterations that may be made in the embodiments and implementations described without departing from the scope of the invention. For example, interactive displays for the functionality described in various embodiments may be displayed in a great variety of ways. In some embodiments icons may be used, in others words or phrases as interactive links. Navigation may be provided directly from links in the displays, or drop-down menus may be provided in some cases. Algorithms for determining values and aggregations may be provided in a variety of ways as well. The scope of the invention is limited only by the claims.

1. An asset tracking and reporting system comprising:
a network-connected computerized appliance having at least one processor and one or more data repositories, at least one of the data repositories being non-transitory; and
coded instructions executing on the at least one processor from the at least one non-transitory data repository, the coded instructions causing the system to:
register individuals or enterprises as users assuming one or more roles;
enable users to enter and edit information through interactive interfaces provided, the information regarding individual assets in defined categories, the assets owned by the user;
track user activities related to user's assets;
connect users to resources to determine value for the individual assets; and
aggregate and report asset valuation according to user identity.

2. The system of claim 1 wherein a profile is established for each user, the profile identifying the user and the user's roles, and linking to the information regarding the user's assets.

3. The system of claim 2 wherein one defined role is expert, and detail of the user's expertise is included in the user profile, made accessible to other users.

4. The system of claim 3 wherein the expert user is an expert in evaluating worth for one or more specific categories of assets.

5. The system of claim 1 wherein users are enabled to communicate with one another and records of communication are recorded and stored as threads associated with the users in each communication.

6. The system of claim 5 wherein individual users are enabled to retrieve and utilize communication threads in asset management.

7. The system of claim 1 wherein individual users are enabled to retrieve and utilize recorded user activities in asset management.

8. The system of claim 5 wherein user communication is leveraged to provide a vehicle for sale and trade of user's assets.

9. The system of claim 1 wherein individual users are provided with a starting page after log in, the starting page displaying at least a financial overview for the user according to asset type.

10. The system of claim 1 wherein at least one aggregate score is determined for a user, the score determined by aggregating weighted values of scores determined per defined asset category for the user, and scores are made available to interested parties.

11. An asset tracking and reporting method comprising:
registering individuals or enterprises as users assuming one or more roles by a network-connected computerized appliance having at least one processor and one or more data repositories, at least one of the data repositories being non-transitory, the processor executing coded instructions on the at least one processor from the at least one non-transitory data repository;
enabling users to enter and edit information through interactive interfaces provided, the information regarding individual assets in defined categories, the assets owned by the user;
tracking user activities related to user's assets;
connecting users to resources to determine value for the individual assets; and
aggregating and reporting asset valuation according to user identity.

12. The method of claim 1 further establishing a profile for each user, the profile identifying the user and the user's roles, and linking to the information regarding the user's assets.

13. The method of claim 12 wherein one defined role is expert, and detail of the user's expertise is included in the user profile, made accessible to other users.

14. The method of claim 13 wherein the expert user is an expert in evaluating worth for one or more specific categories of assets.

15. The method of claim 11 wherein users are enabled to communicate with one another and records of communication are recorded and stored as threads associated with the users in each communication.

16. The method of claim 15 wherein individual users are enabled to retrieve and utilize communication threads in asset management.

17. The method of claim 11 wherein individual users are enabled to retrieve and utilize recorded user activities in asset management.

18. The method of claim 15 wherein user communication is leveraged to provide a vehicle for sale and trade of user's assets.

19. The method of claim 11 wherein individual users are provided with a starting page after log in, the starting page displaying at least a financial overview for the user according to asset type.

20. The method of claim 1 wherein at least one aggregate score is determined for a user, the score determined by aggregating weighted values of scores determined per defined asset category for the user, and scores are made available to interested parties.
